(19) United States
(12) Patent Application Publication
(10) Pub. No.: US 2014/0108973 A1
(43) Pub. Date: Apr. 17, 2014

(54) SYSTEM AND METHOD TO GENERATE A TARGETED AUDIENCE

(71) Applicants: Kevin Stark, Indianapolis, IN (US); Jim McIntosh, McCordsville, IN (US); Rob Gardziel, San Francisco, CA (US); Chuck Moore, Mill Valley, CA (US); Susan Gordhammer, Park City, UT (US); Jason Day, Fishers, IN (US)

(72) Inventors: Kevin Stark, Indianapolis, IN (US); Jim McIntosh, McCordsville, IN (US); Rob Gardziel, San Francisco, CA (US); Chuck Moore, Mill Valley, CA (US); Susan Gordhammer, Park City, UT (US); Jason Day, Fishers, IN (US)

(73) Assignee: ExactTarget, Inc., Indianapolis, IN (US)

(21) Appl. No.: 14/054,231

(22) Filed: Oct. 15, 2013

Related U.S. Application Data
(60) Provisional application No. 61/714,076, filed on Oct. 15, 2012.

(51) Int. Cl. G06F 3/0484

(52) U.S. Cl. CPC G06F 3/0484
USPC 715/762

(57) ABSTRACT

A computerized method and system for generating a graphical user interface to build an audience is disclosed including receiving a plurality of filtering attributes from a database, the filtering attributes representing characteristics associated with a plurality of recipients, generating a graphical user interface comprising a plurality of lines and at least one Boolean operand, binding at least one attribute and at least one range to each row, grouping a plurality of lines with the at least one Boolean operand to generate a Boolean expression, and executing the Boolean expression to filter the plurality of recipients based on the characteristics in the database.

### PRIORITY

This application claims priority to and the benefit of U.S. Provisional Application No. 61/714,076, filed on Oct. 15, 2012 which is incorporated herein by reference.

### BACKGROUND

The expansion of social media, email, mobile networking, and other conversation mediums has created a flood of communications from enterprises to consumers. Wading through these communications, consumers discard or do not read any item in which the consumer immediately does not find relevant. As such, read rates, click rates, and overall marketing metrics associated with campaigns that use these conversation mediums are at risk to be much lower than ever before.

Consumers trying to lessen the amount of irrelevant communications received may choose to opt out of those that the consumer does not find relevant. Certain rules, laws, and regulations may require that an enterprise cease sending marketing materials to a consumer that opts out of such communications. Thus, an enterprise that sends irrelevant materials to a consumer may lose the ability to continue marketing to that consumer in the event that the consumer chooses to opt out or unsubscribe from communications.

Accordingly, there exists a need for a system that enables an enterprise to efficiently create targeted audiences based on demographic information for communications within a marketing campaign.

### BRIEF DESCRIPTION OF THE DRAWINGS

FIG. 1 illustrates a graphical user interface of a system to generate a targeted audience according to at least one embodiment of the present disclosure.

FIG. 2A illustrates a graphical user interface of a system to generate a targeted audience according to at least one embodiment of the present disclosure.

FIG. 2B illustrates a graphical user interface of a system to generate a targeted audience according to at least one embodiment of the present disclosure.

FIG. 2C illustrates a graphical user interface of a system to generate a targeted audience according to at least one embodiment of the present disclosure.

FIG. 2D illustrates a graphical user interface of a system to generate a targeted audience according to at least one embodiment of the present disclosure.

FIG. 2E illustrates a graphical user interface of a system to generate a targeted audience according to at least one embodiment of the present disclosure.

FIG. 2F illustrates a graphical user interface of a system to generate a targeted audience according to at least one embodiment of the present disclosure.

FIG. 2G illustrates a graphical user interface of a system to generate a targeted audience according to at least one embodiment of the present disclosure.

FIG. 3A illustrates a graphical user interface of a system to generate a targeted audience according to at least one embodiment of the present disclosure.

FIG. 3B illustrates a graphical user interface of a system to generate a targeted audience according to at least one embodiment of the present disclosure.

FIG. 3C illustrates a graphical user interface of a system to generate a targeted audience according to at least one embodiment of the present disclosure.

FIG. 3D illustrates a graphical user interface of a system to generate a targeted audience according to at least one embodiment of the present disclosure.

FIG. 3E illustrates a graphical user interface of a system to generate a targeted audience according to at least one embodiment of the present disclosure.

FIG. 3F illustrates a graphical user interface of a system to generate a targeted audience according to at least one embodiment of the present disclosure.

FIG. 3G illustrates a graphical user interface of a system to generate a targeted audience according to at least one embodiment of the present disclosure.

FIG. 4A illustrates a graphical user interface of a system to generate a targeted audience according to at least one embodiment of the present disclosure.

FIG. 4B illustrates a graphical user interface of a system to generate a targeted audience according to at least one embodiment of the present disclosure.

FIG. 4C illustrates a graphical user interface of a system to generate a targeted audience according to at least one embodiment of the present disclosure.

FIG. 4D illustrates a graphical user interface of a system to generate a targeted audience according to at least one embodiment of the present disclosure.

FIG. 4E illustrates a graphical user interface of a system to generate a targeted audience according to at least one embodiment of the present disclosure.

FIG. 5A illustrates a graphical user interface of a system to generate a targeted audience according to at least one embodiment of the present disclosure.

FIG. 5B illustrates a graphical user interface of a system to generate a targeted audience according to at least one embodiment of the present disclosure.

FIG. 6 illustrates a graphical user interface of a system to generate a targeted audience according to at least one embodiment of the present disclosure.

FIG. 7 illustrates a graphical user interface of a system to generate a targeted audience according to at least one embodiment of the present disclosure.

FIG. 8A illustrates a graphical user interface of a system to generate a targeted audience according to at least one embodiment of the present disclosure.

FIG. 8B illustrates a graphical user interface of a system to generate a targeted audience according to at least one embodiment of the present disclosure.

FIG. 8C illustrates a graphical user interface of a system to generate a targeted audience according to at least one embodiment of the present disclosure.

FIG. 8D illustrates a graphical user interface of a system to generate a targeted audience according to at least one embodiment of the present disclosure.

FIG. 8E illustrates a graphical user interface of a system to generate a targeted audience according to at least one embodiment of the present disclosure.

FIG. 9 illustrates an architecture of a system to generate a targeted audience according to at least one embodiment of the present disclosure.

FIG. 10 displays a flowchart of a method to generate a targeted audience according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

A system to generate a targeted audience is described herein. The audience builder system may include a computer readable medium for storing information in one or more fields and a microprocessor that is coupled to the computer readable medium. The microprocessor may be programmed with instructions for manipulating the information. The audience builder system may also include a display screen that is coupled to the computer readable medium. The display screen may be configured to display the information to a user of the cost management system and to permit selection of the one or more fields by the user. The audience builder system may further include one or more software processes stored on the computer readable medium where such processes may be executed on the microprocessor. One or more of these software processes may allow a user to provide information to the audience builder system, wherein such information may include one or more of demographic information of the target audience, search terms to find types of demographic information, and other information. This detailed description is presented in terms of programs, data structures or procedures executed on a computer or network of computers. The software programs implemented by the system may be written in languages such as Java, HTML, Python, C++, C#, or the ASP.Net programming language. However, one of skill in the art will appreciate that other languages may be used instead, or in combination with the foregoing.

For purposes of illustration, the present disclosure relates to a system, method, and software product directed to building a targeted audience based on demographic information for a marketing campaign. In one embodiment of the present disclosure, the system receives or obtains data from a database of demographic information and a user. Based on the information obtained from the database and manipulated by the user, the system generates a targeted audience.

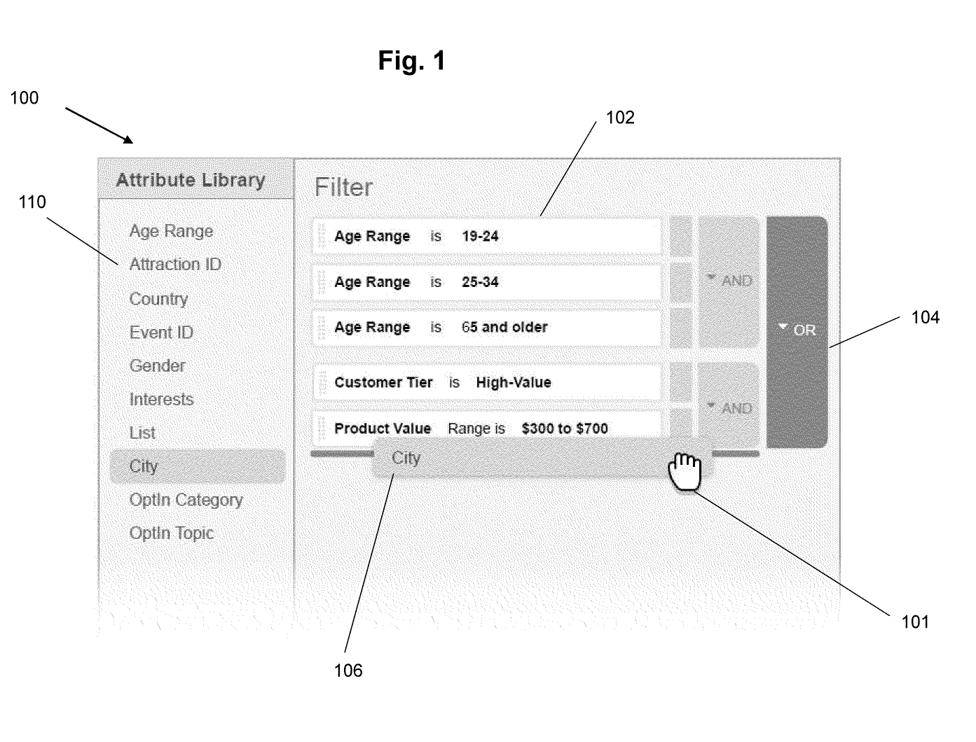

Referring now to FIG. 1, a graphical user interface displaying a system to generate a targeted audience is shown. In at least one embodiment of the present disclosure, the graphical user interface 100 is displayed to a user by the user connecting to the system over a network, such as, for example, the Internet. In such an embodiment, the user connects to the system using a client device, such as, for example, a personal computer, a laptop, a netbook, a mobile phone, a tablet, or any other interactive device with network connectivity. It should be appreciated that it is within the scope of this disclosure that the user may connect locally to the system to display the graphical user interface 100 and, therefore, a network is not required.

In at least one embodiment of the present disclosure, upon connecting to the system, the user is presented with the graphical user interface 100. The graphical user interface 100 includes an audience filter pane 102, a set of Boolean operands 104, a user input pointer 105, and an attribute library 110. In at least one embodiment of the present disclosure, the user may select one or more attributes from the attribute library 110 with the user input pointer 105 to drag the attribute 106 to the filter pane 102.

In at least one embodiment of the present disclosure, the graphical user interface 100 includes an attribute library 110. In at least one embodiment of the present disclosure, the attribute library 110 holds the types of demographic information able to be selected by the user to include in building a targeted audience. Attributes within the attribute library 110 are variables defining types of data within a database or other storage medium about an audience. In at least one embodiment of the present disclosure, each attribute within the attribute library 110 may be selected by the user to include as filtering criteria when generating an audience. Attributes may include, but are not limited to, demographic information such as age range, identification number, country, event number in which the information was obtained, gender, interests, city, an opt-in category, an opt-in topic, type of user device, and education.

For example, the attribute library may include age range, gender, and city. A user intending to create a targeted audience for a campaign surrounding discounts available to senior citizens for a men's golf glove in Pasadena, Calif. may select age range, gender, and city from the attribute library 110. By selecting these attributes, the user identifies that the targeted audience the user intends to create will be filtered by age range, gender, and city. In this example, the user might eventually select men with an age range of over the age of 55 who live in Pasadena, Calif.

In at least one embodiment of the present disclosure, the user may select attributes from the attribute library 110 by using the user input pointer 105 and drag the selected attribute 106 into the filtering pane 102. The user input pointer 105 includes any type of input device on a user device, such as, for example, a mouse, a keyboard, or a touchpad. By interacting with the graphical user interface 100 with the user input pointer device, the user may move the user input point 105 to select attributes from the attribute library 110, place the selected attribute 106 into the filter pane 102, and interact with the Boolean operands 104 all to modify the targeted audience generated by the system. It should be appreciated that the through user input the user may select a variety of filtered queries to generate the targeted audience. It should be appreciated that the generated target audience may be modified by the user at a whim through interaction with the graphical user interface 100.

In at least one embodiment of the present disclosure, selected attributes 106 that are placed into the filtering pane 102 generate the selectable attributes that will be evaluated by the system to determine the targeted audience. In at least one embodiment of the present disclosure, selected attributes 106 placed into the filter pane 102 may be further defined by the user to define the target information that user is interested in. For example, the selected attribute 106 for age range in the filter pane 102 may include the range of 19 year olds to 24 year olds, 25 year olds to 34 year olds, and over 65 years old. In another example, the selected attribute 106 for customer tier that is moved into the filter pane 102 may include the identification of a high-value customer.

It should be appreciated that the user may select zero, one or many attributes from the attribute library 110 to move into the filter pane 102 to generate the targeted audience in the system. As shown in the filter pane 102, the user may also select the same attribute multiple times in the event that the user intends to include multiple filtering criteria for such attribute. For example, multiple age ranges are selected as shown in FIG. 1. It should be appreciated that the attributes that the user selects depend on the targeted audience that the user is intending to generate based on certain demographic information. For example, an enterprise user intending to create a targeted audience based on the list of female users within a database that have opted in to receiving communications from the enterprise may select the gender attribute and the opt-in category attribute from the attribute pane 110 and drag the selected attributes 106 into the filter pane 102. Then, within the filter pane 102, the user may define the demographic information associated with such attributes that the user is interested in filtering, such as, for example, the female gender and a status the a person has opted in to receiving communications from the enterprise.

In at least one embodiment of the present disclosure, the graphical user interface 100 updates the demographic information that may be filtered from the attributes in the filtering pane 102 based on the available demographic information within a database. For example, as shown in FIG. 1, the filtering pane 102 includes the attribute “Age Range” with multiple ranges of ages shown: 19-24, 25-34, and 65 and older. In this example and according to at least one embodiment of the present disclosure, the age ranges populated in the filtering pane 102 are generated from a list of known age ranges stored in a database. In at least one embodiment of the present disclosure, the user manually types in the selected age ranges to include in the filtering pane 102.

In at least one embodiment of the present disclosure, the graphical user interface 100 includes one or more Boolean operands 104. In at least one embodiment of the present disclosure, the Boolean operands 104 further define the filtering criteria within the filtering pane 102 such that the Boolean operands 102 define the relationships between the attributes within the filtering pane 102 to select the targeted audience. For example, as shown in FIG. 1, the Boolean operands 104 include a global “OR” operand, an “AND” operand applied to the Age Ranges of 19-24, 25-34, and 65 and older, and an “AND” operand applied to a “Customer Tier” of “High-Value” and a “Product Value Range” of “$300 to $700”. In this example, the Boolean operands will apply to the filtering criteria in the filtering pane 102 to only select audience members that are of the age range of 19-24 and 25-34 and 65 and older or audience members associated with a “High-Value” “Customer Tier” and a “Product Value Range” between $300 to $700. In this example, the Boolean operands applied to the “Age Range” attributes will select zero audience members because they create a conflicting set of attributes, so the filtering criteria will only select audience members associated with a “High-Value” “Customer Tier” and a “Product Value Range” between $300 to $700. It should be appreciated that in this example the user could interact with the graphical user interface 100 to modify the attributes within the filtering pane 102 or to modify the Boolean operands 104 to achieve a different result. It should be appreciated that any combination of attributes within the attribute library 110 for selection within the filtering pane 102 and Boolean operands 104 is possible within the graphical user interface 100.

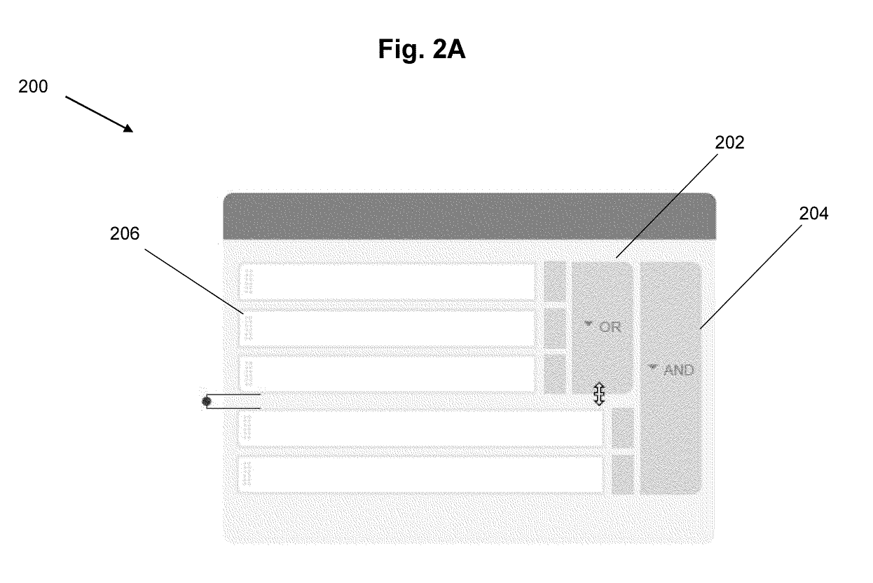

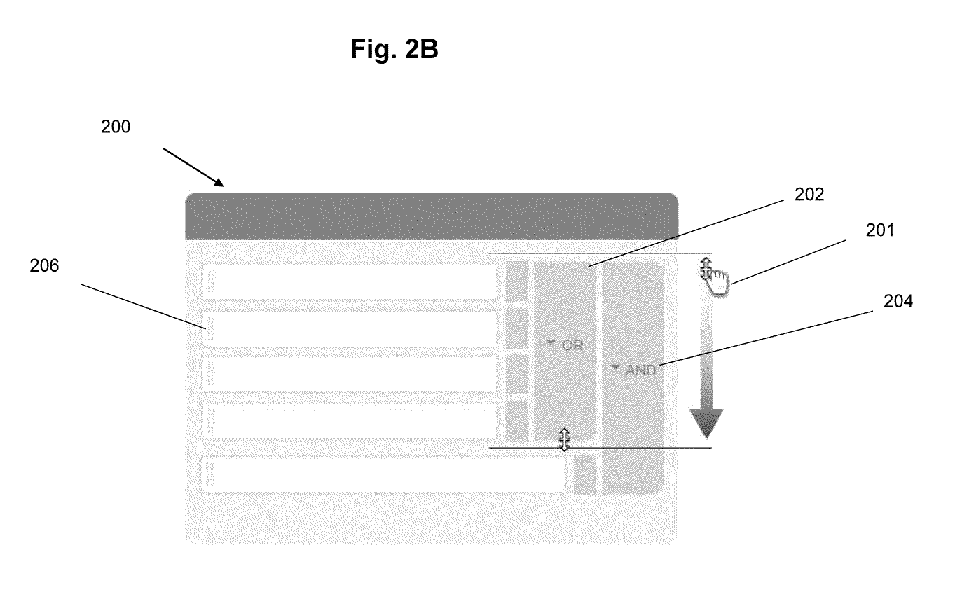

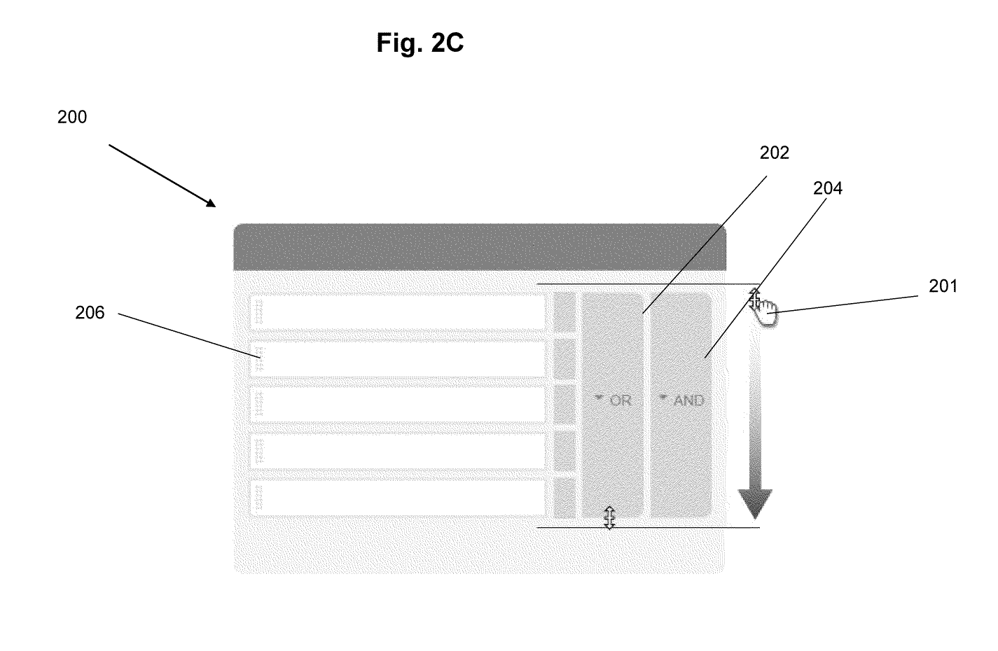

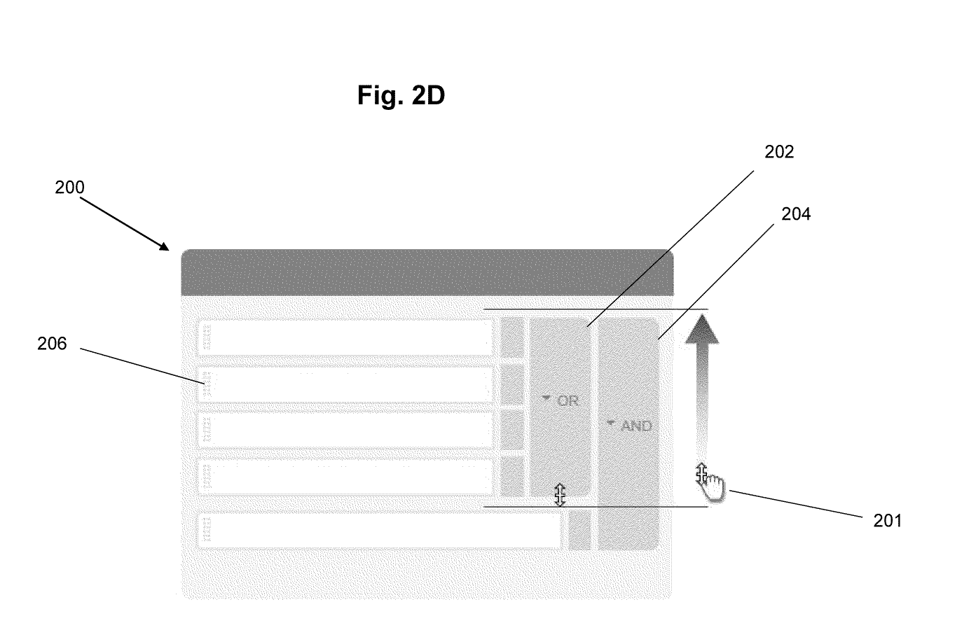

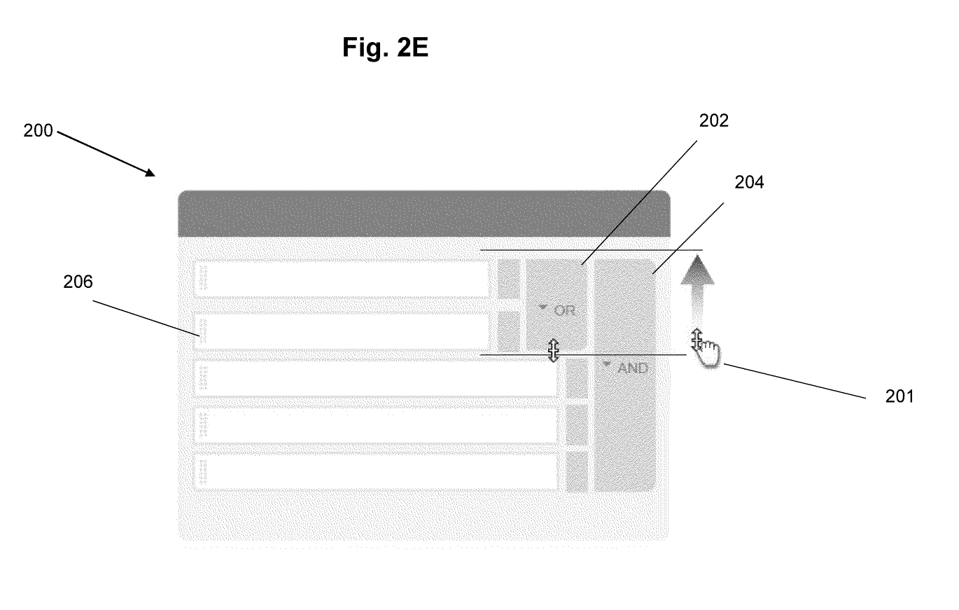

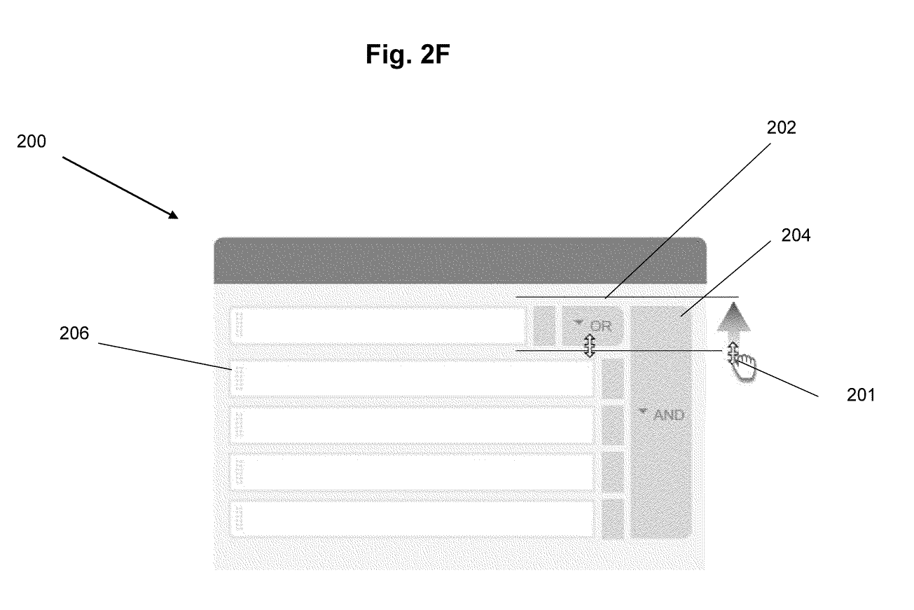

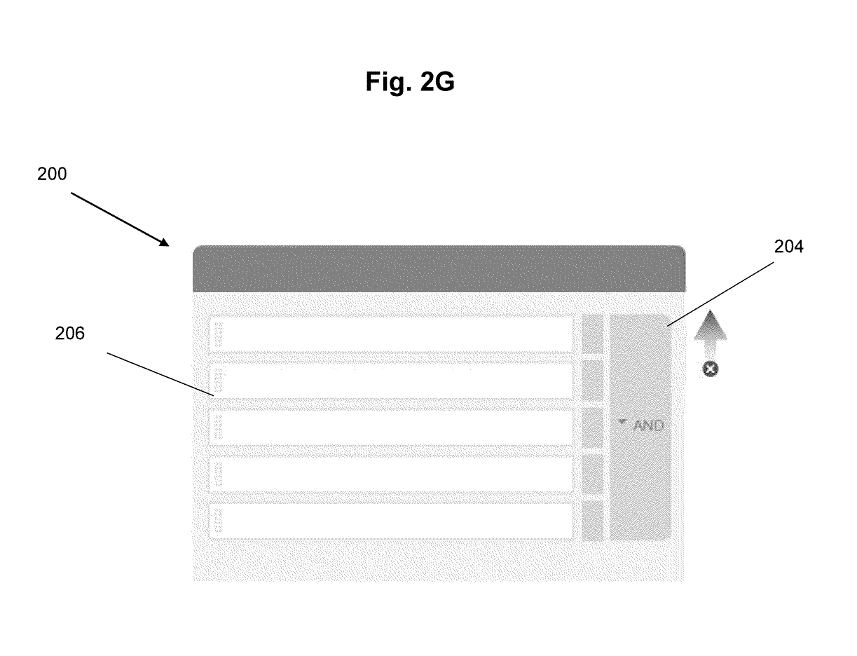

In at least one embodiment of the present disclosure, a user may modify the attributes and Boolean operands through direct interaction within the graphical user interface. This interaction enables the user to quickly and efficiently change the selected criteria in order to generate a targeted audience with the system. In the event that the generated targeted audience is not what the user wanted, the user may quickly and efficiently modify the targeted audience by altering the selected filtering criteria and Boolean operands to achieve a different result. For example, referring now to FIG. 2A, the graphical user interface 200 includes a set of selected attributes 206, the Boolean operand AND 204, and the Boolean operand OR 202. As shown in FIG. 2A, the Boolean operand AND 204 is applied to all of the selected attributes 206, while the Boolean operand OR 202 is applied to only three of the selected attributes 206.

Referring now to FIG. 2B, in one example, the user may alter the Boolean operand OR 202 by interacting with the Boolean operand OR 202 through a user input pointer 201. In this example, the user's interaction with the Boolean operand OR 202 to slide it downward causes the Boolean operand OR 202 to apply to four of the selected attributes 206 as opposed to three of the selected attributes 206 as shown in FIG. 2A.

It should be appreciated that the ability of the user to alter the selected attributes 206 in which the Boolean operands are applied allows the user to efficiently and quickly alter the generated target audience by the system to achieve the desired targeted audience. For example, by altering the OR operand 202 as shown in FIG. 2A and FIG. 2B, the user adds an additional selected attribute to the scope of the OR operand 202. In this example, the additional selected attribute may expand the targeted audience generated by the system to include more persons and, therefore, to increase the targeted audience.

Referring now to FIG. 2C, in one example, the user may alter the Boolean operand OR 202 by interacting with the Boolean operand OR 202 through a user input pointer 201. In this example, the user expands the Boolean OR operand 202 to include a sixth selected attribute 206 and, therefore, to alter the targeted audience generated by the system. In another example, referring now to FIG. 2D, the user may move the Boolean operand OR upwards to its previous position and, therefore, have the Boolean operand OR 202 applied to only five selected attributes 206. Referring now to FIG. 2E, the user may adjust the Boolean operand OR 202 to only apply to two selected attributes 206 by moving its position upwards. In another example, as shown in FIG. 2F, the user may slide the Boolean operand OR 202 to only apply to one of the selected attributes 206. In another example as shown in FIG. 2F, the user may slide the Boolean operand OR all the way to beyond the first selected attribute 206 to delete the Boolean operand OR from the graphical user interface 200.

It should be appreciated that the previous examples demonstrate that the Boolean operands may be adjusted by the user to apply to zero, one, or any of the selected attributes from the attribute library in the filtering pane. The quick and efficient manner in which a user may modify the Boolean operands, add or remove selected attributes, and modify the values within the graphical user interface enables the user to obtain a desired target audience.

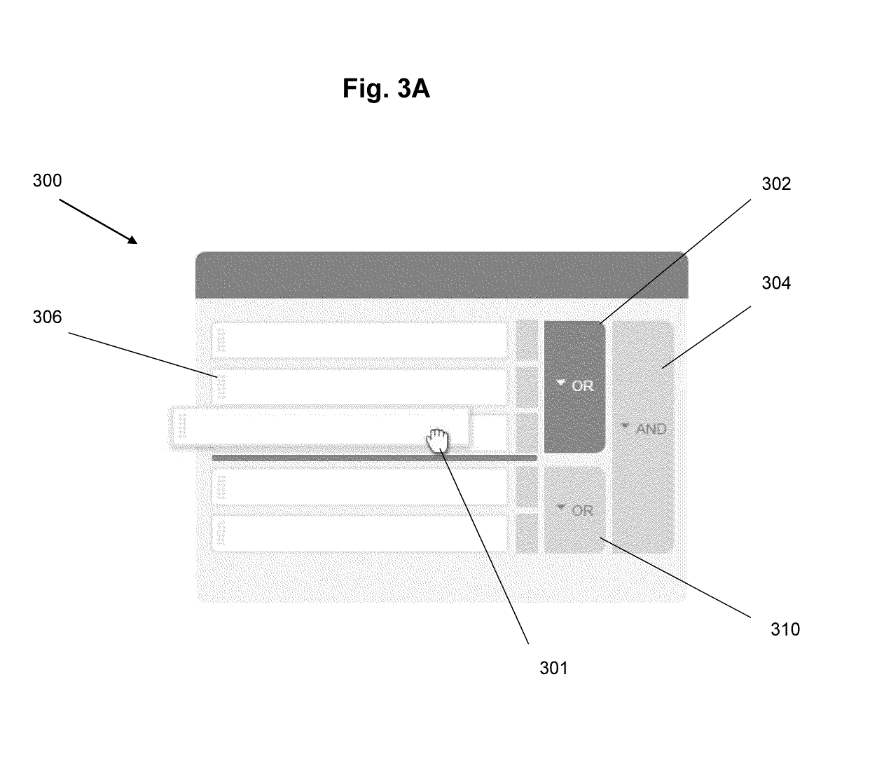

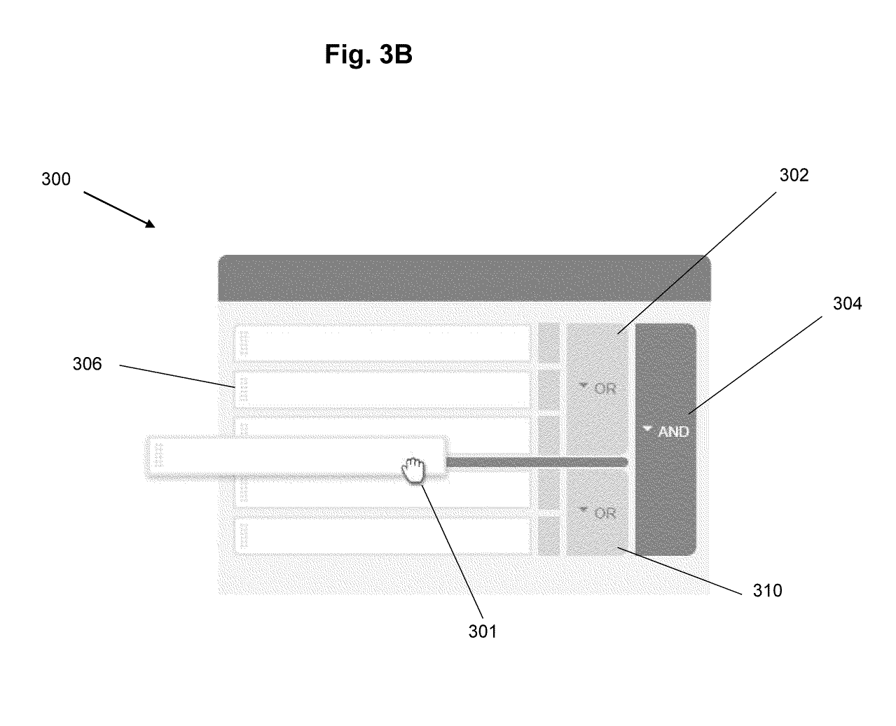

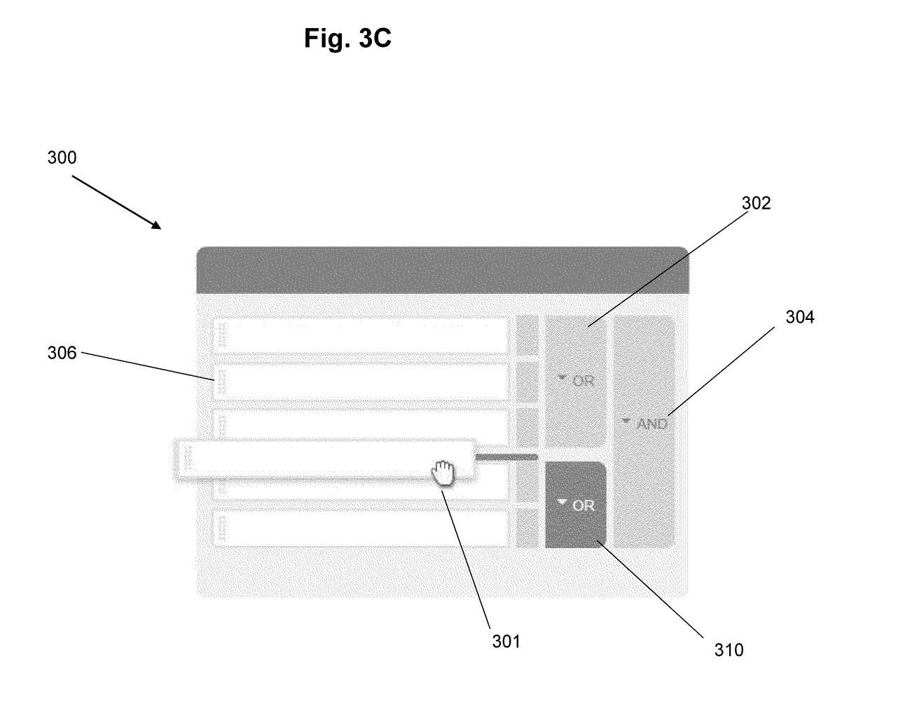

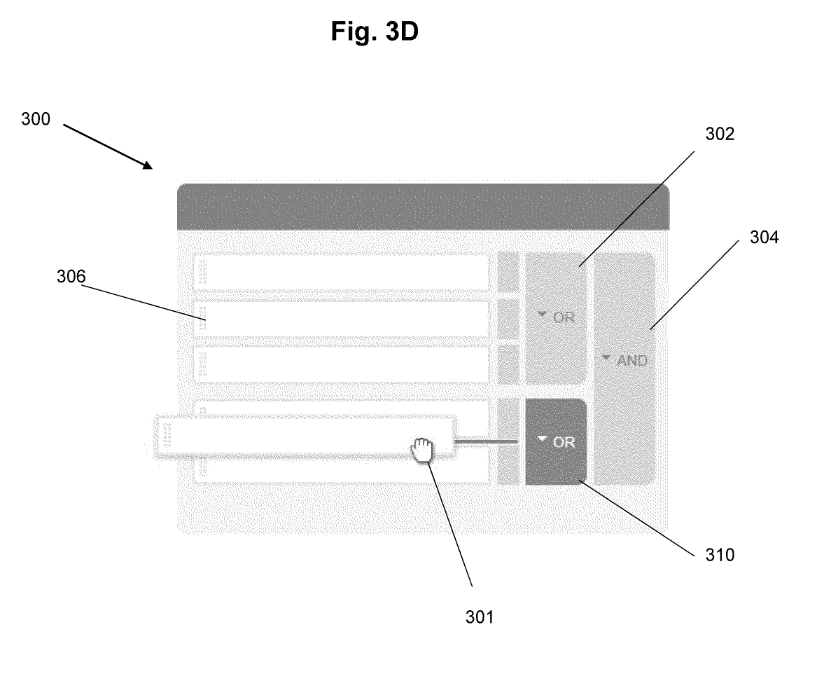

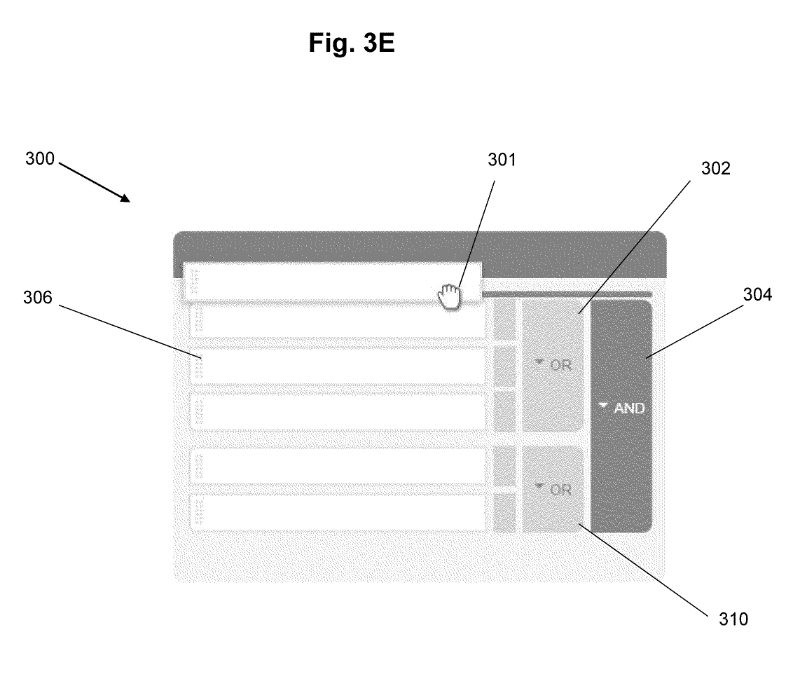

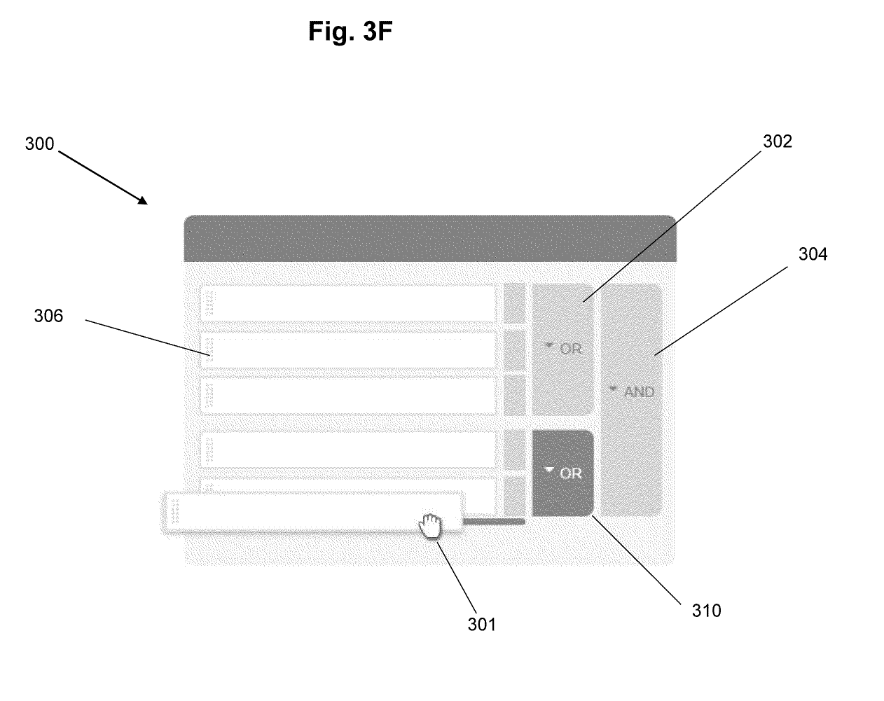

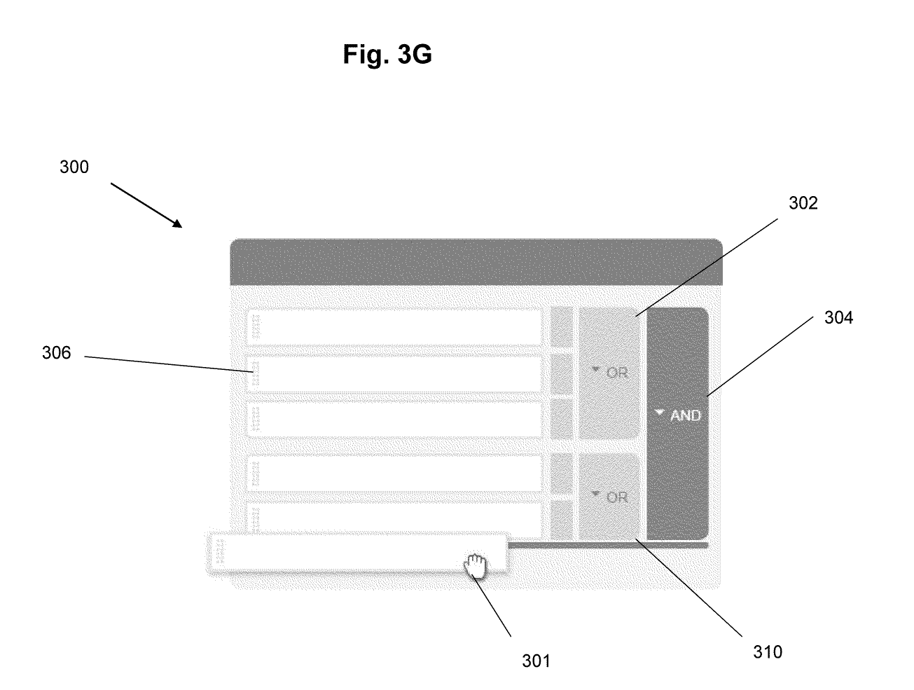

In at least one embodiment of the present disclosure, a user may move selected attributes around the graphical user interface within the audience builder system in order to group selected attributes among various Boolean operands. Referring now to FIG. 3A, a graphical user interface 300 of an audience builder system is shown. As shown in FIG. 3A, five selected attributes 306 are within a filtering pane. The five selected attributes 306 are grouped within an OR Boolean operand 302, another OR Boolean operand 310, and an AND Boolean operand 304. A user through a user input pointer 301 may move any of the selected attributes 306, add a new selected attribute to the selected attributes 306, delete a selected attribute 306, and otherwise interact with the selected attributes 306 within the graphical user interface 300. In at least one embodiment of the present disclosure, as the user moves a selected attribute to different positions with the graphical user interface 300, an indicator bar directs the user as to where the selected attribute will be placed and, therefore, which Boolean operands will be applied to the selected attribute.

As shown in FIG. 3A, a user may move a selected attribute 306 to a new position through the user input pointer 301. In this example, by moving the selected attribute 306 to the position shown, the selected attribute 306 will be applied to the OR Boolean operand 302. In another example, referring now to FIG. 3B, the user may move the selected attribute 306 to a different position within the graphical user interface 300 such that the selected attribute 306 is applied to the AND Boolean operand 304. In another example, referring now to FIG. 3C, the user may move the selected attribute 306 to a different position in the graphical user interface such that the selected attribute 306 is applied to the OR Boolean operand 310. It should be appreciated that the user may move the selected attribute 306 to any position within the graphical user interface such that it is applied to various Boolean operands, such as, for example, as shown in FIG. 3D, FIG. 3E, FIG. 3F, and FIG. 3G.

In at least one embodiment of the present disclosure, a user may add, remove, or move Boolean operands to a graphical user interface of an audience builder system. In such an embodiment, the user applies the added Boolean operands to the graphical user interface to one or more of a set of selected attributes from an attribute library within the graphical user interface. In at least one embodiment of the present disclosure, the user may quickly and efficient move the Boolean operands within the graphical user interface in order to produce the desired target audience from the audience builder system.

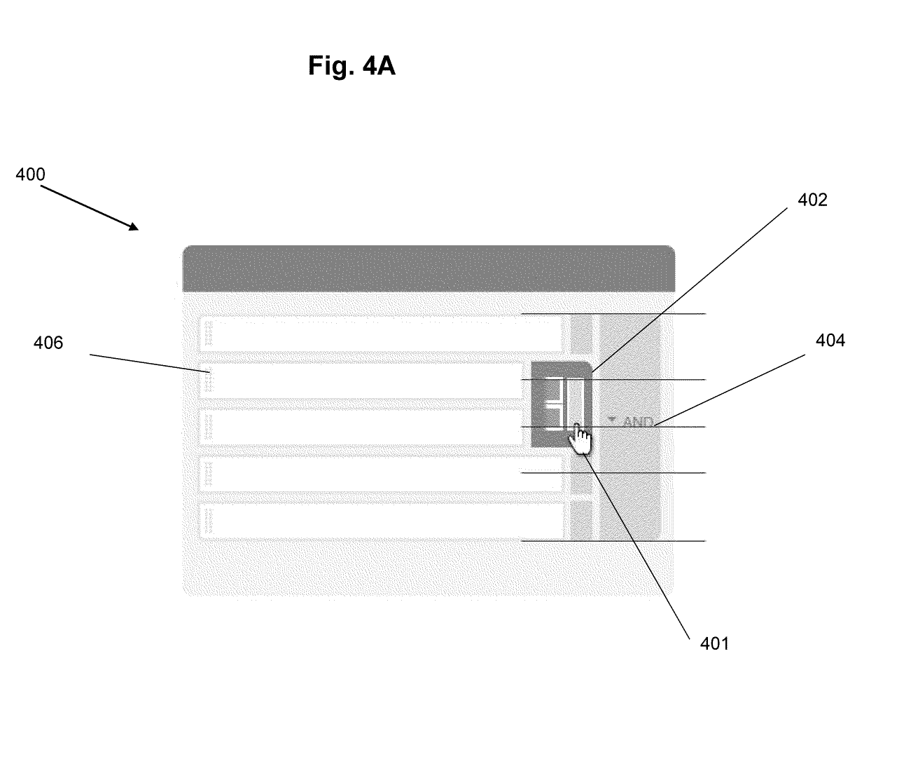

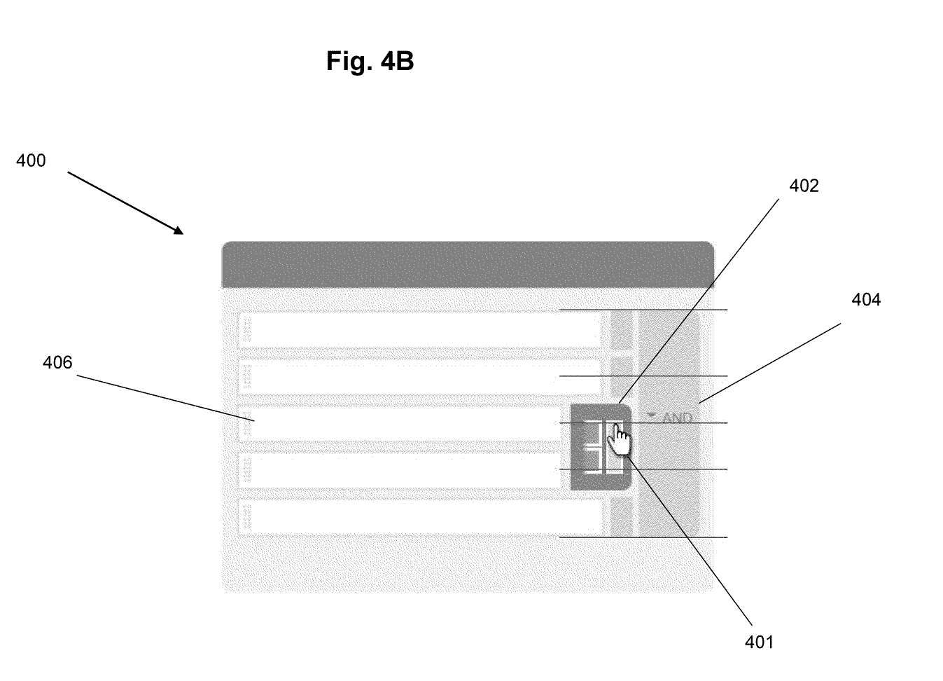

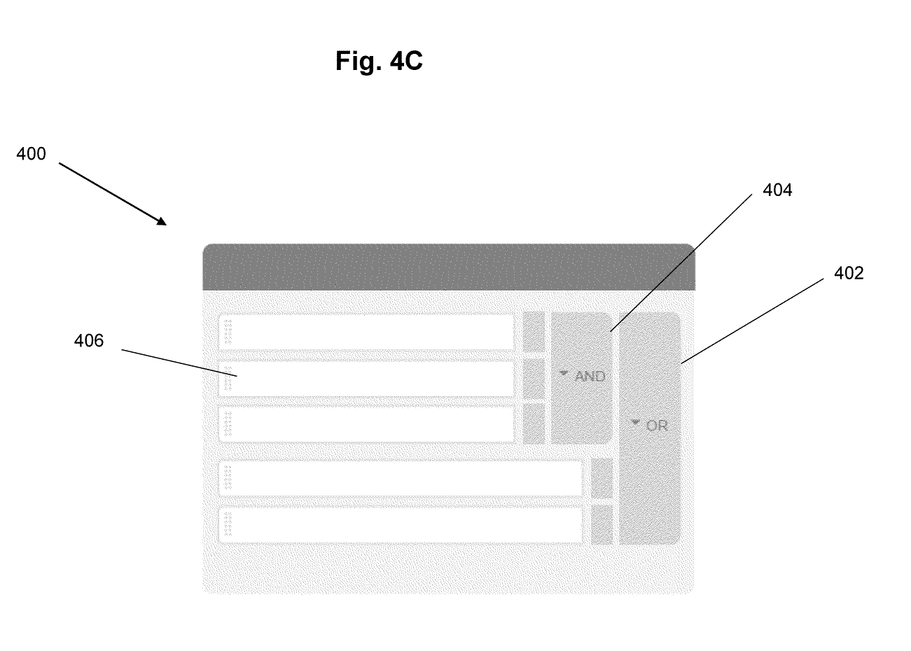

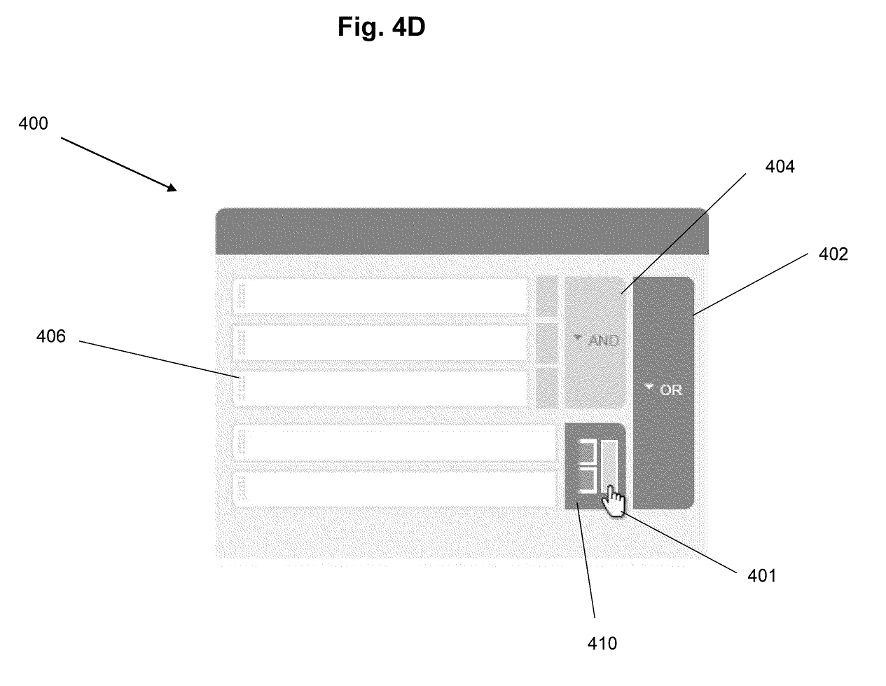

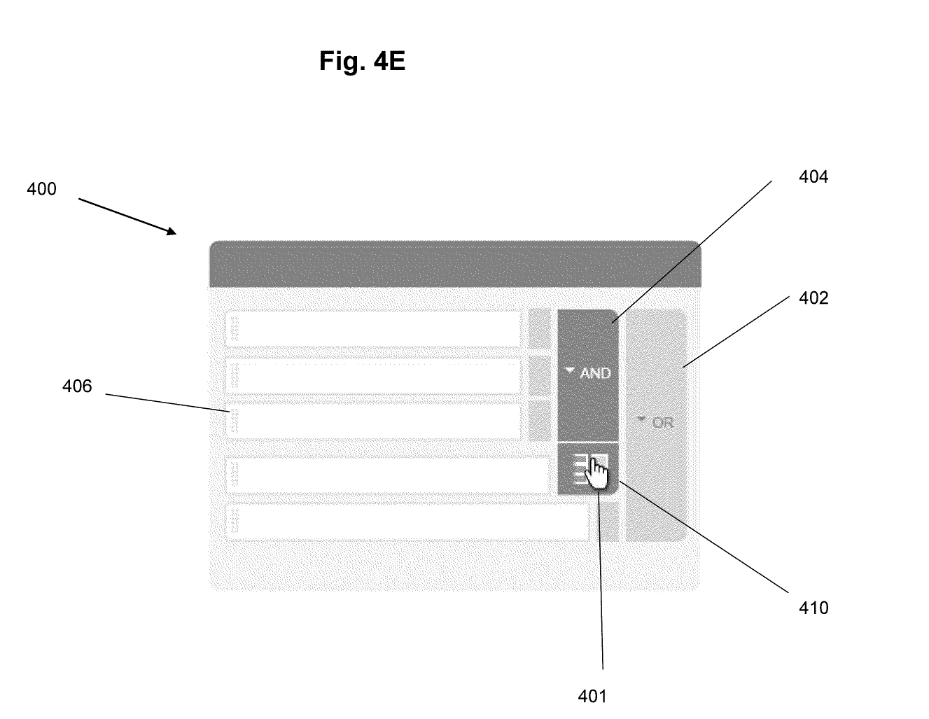

Referring now to FIG. 4A, it is shown a graphical user interface 400 of an audience builder system according to at least one embodiment of the present disclosure. In at least one embodiment of the present disclosure, the graphical user interface 400 includes a set of selected attributes 406 from an attribute library, an AND Boolean operand 404, and a user input pointer 401.

In such an embodiment, a user may add, remove, or modify the Boolean operands found within the graphical user interface in order to change the targeted audience generated by the system. As shown, for example, in FIG. 4A, a user may add an additional Boolean operand 402 to the graphical user interface and apply the additional Boolean operand 402 to two of the selected attributes 406. Referring now to FIG. 4B, in at least one embodiment of the present disclosure, the user may move the added Boolean operand 402 within the graphical user interface 400 to apply the Boolean operand to a different set of selected attributes 406 using the user input pointer 401.

Referring now to FIG. 4C, in at least one embodiment of the present disclosure, the user may move each of the Boolean operands within the graphical user interface 400 to apply the Boolean operands to any or all of the selected attributes 406. As shown, for example, in FIG. 4C, the user moved the added Boolean operand 402 to apply to all of the selected attributes 406 and defined the added Boolean operand 402 to be an OR Boolean operand. As shown, for example, in FIG. 4C, the user moved the AND Boolean operand 404 from its previous position as shown in FIG. 4A and FIG. 4B to only apply to three of the selected attributes 406 instead of all of the selected attributes 406. It should be appreciated that the user may move the Boolean operands to apply to none, one, some, or all of the selected attributes 406 depending on the Boolean expression that the user wishes to form through the graphical user interface 400 to be executed against a target database by the audience builder system. In at least one embodiment of the present disclosure, by changing the Boolean operands and selected attributes, the user forms different Boolean expressions to be executed by the audience builder system.

In at least one embodiment of the present disclosure, the user may add additional Boolean operands to the graphical user interface 400. As shown, for example, in FIG. 4D, the user drags an additional Boolean operand 410 to the graphical user interface 400 using the user input pointer 401 and applies the added Boolean operand 410 to two of the selected attributes 406. In such an embodiment, the user forms a new Boolean expression by adding the new Boolean operand 410. In at least one embodiment of the present disclosure, the user may modify the added Boolean operand 410 to apply to different selected attributes 406. As shown, for example, in FIG. 4E, the user may move the added Boolean operand 410 to only apply to one of the selected attributes 406. It should be appreciated that the user may add any number of selected attributes and Boolean operands and apply the Boolean operands to none, one, some, or all of the selected attributes.

It should be appreciated that Boolean operand, as used in the present disclosure, may include, but is not limited to, any Boolean operator, such as, for example, OR, AND, NOT. In at least one embodiment of the present disclosure, by building an expression of selected attributes and Boolean operands, the user creates a Boolean expression that is evaluated by the audience builder system. In at least one embodiment of the present disclosure, the Boolean operands applied to a subset of the selected attributes acts to group the selected attributes under one Boolean operand to create the Boolean expression. For example, the Boolean expression created according to at least one embodiment of the present disclosure as depicted from the selected attributes and Boolean operands in FIG. 1 is:
(Age Range is 19-24 AND Age Range is 25-34 AND Age Range is 64 and older)
OR
(Customer Tier is High-Value AND Product Value Range is $300 to $700)

In at least one embodiment of the present disclosure, the Boolean expression generated from the user input is applied to a target database by the audience builder system to generate a target audience. Once generated, the user may evaluate and the review the generated target audience. In the event that the Boolean expression did not generate the desired target audience, the user may modify the Boolean expression, by modifying the inputs represented in the graphical user interface, in order to generate a new target audience. In at least one embodiment of the present disclosure, once the target audience is finalized, the user may use the target audience as a list of addressees in a marketing campaign.

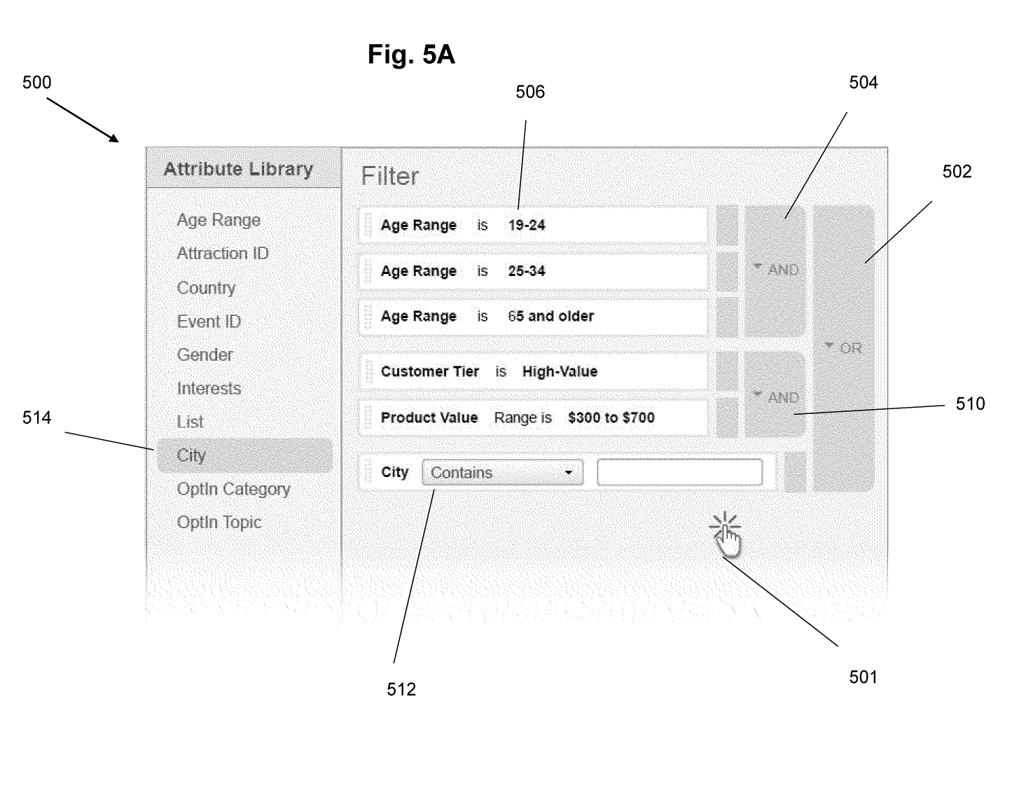

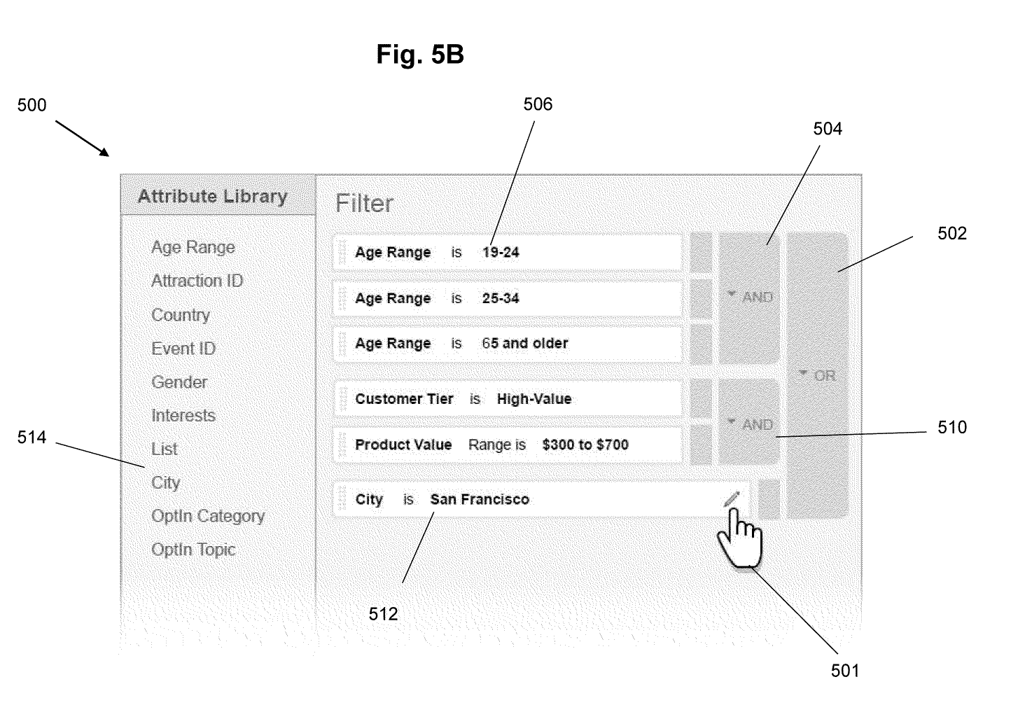

In at least one embodiment of the present disclosure, a user may further define selected attributes with filtering criteria to include in a Boolean expression to be executed by an audience builder system. As an example, referring now to FIG. 5A, a user may select a multitude of selected attributes 506 from an attribute library 514 and Boolean attributes 502, 504, 510 to include in a Boolean expression within a graphical user interface 500 to be executed by the audience builder system. In this example, the selected attributes 506 are further defined by filtering criteria that impacts the selected attributes 506. As shown in FIG. 5A, three filtering criteria are configured by the user for the Age Range selected attribute 506 (“19-24”, “25-34”, and “65 and older”). In this example, the user has also included filtering criteria for the selected attribute of Customer Tier (“High-Value”) and filtering criteria for the selected attribute 506 of Product Value (“Range is $300 to $700”).

As shown, in this example, on FIG. 5A, the filtering criteria may include user-defined input, selected options, and custom variable types. For example, as shown in FIG. 5A, the user may input filtering criteria through a text box for a selected attribute with a pre-defined filtering phrase 512. For example, the City selected attribute may have a pre-defined filtering phrase, such as, for example, contains, equals, is less than, is greater than, does not equal, or other filtering terms. In association with the filtering phrase for the selected attribute, the user may enter input. For example, a user may input a portion of a city name, such as, for example, “San”. In at least one embodiment of the present disclosure, the user's input will be part of the filtering criteria for the selected attribute. When the Boolean expression is executed by the audience builder system, the filtering criteria is evaluated to find appropriate audience members. In this example, the filtering criteria for the selected attribute of “City” is “Contains” and “San”. In this example, the filtering criteria when executed will match entries in the database in which the City value contains the phrase “San”, such as, for example, “San Francisco”, “San Diego”, and “San Jose”.

In at least one embodiment of the present disclosure, the user may select predefined values for filtering criteria. Referring now to FIG. 5B, an example is shown where a user has selected the predefined value for the City selected attribute of “San Francisco” 512. In this example, when the Boolean expression is evaluated, the City selected attribute will be filtered to only include entries that match the selected filtering criteria of “San Francisco”. In at least one embodiment of the present disclosure, the user may click the selected attribute to input a new value, select a new value, or otherwise interact with the selected attribute.

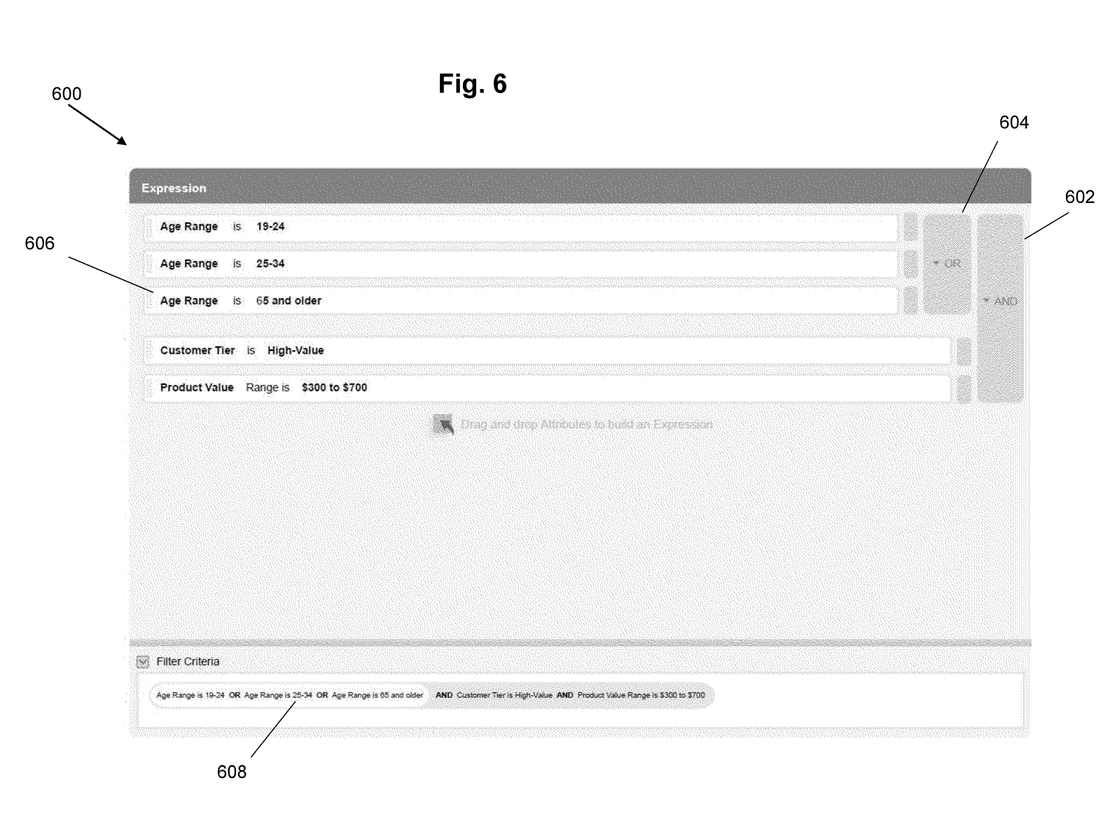

Referring now to FIG. 6, it is shown a graphical user interface to create a Boolean expression to be executed by an audience builder system according to at least one embodiment of the present disclosure. In at least one embodiment of the present disclosure, the graphical user interface 600 includes selected attributes 606, Boolean operands 602, 604 and a preview of a Boolean expression 608. In at least one embodiment of the present disclosure, the preview of a Boolean expression 608 displays the resulting Boolean expression that will be executed by the audience builder system based on the layout of the selected attributes 606 and the Boolean operands 602, 604 in the graphical user interface. In such an embodiment, the preview of a Boolean expression 608 changes as the user modifies the selected attributes 706, inputs new filtering criteria, and/or modifies, adds to, or removes the Boolean operands 602, 604.

As shown in FIG. 6, for example, in the event that a user selects the selected attributes 606 “Age Range”, “Customer Tier” from an attribute library, the user also selects the Boolean operands OR 604 and AND 602, and the user positions the selected items on the graphical user interface 600 as shown in FIG. 6, the audience builder system generates a preview of the Boolean expression 608 that will be executed. As shown, for example, the preview of the Boolean expression 608 displays the Boolean expression (Age Range is 19-24 OR Age Range 25-34 OR Age Range is 65 and older) AND (Customer-Tier is High-Value AND Product Value Range is $300 to $700) which corresponds to the selected items by the user displayed in the graphical user interface 600. In this example, in the event that the user moves any of the selected attributes 606, modifies filtering criteria, and/or modifies any of the Boolean operands 602, 604, then the preview of the Boolean expression 608 changes to reflect the changes made by the user in the graphical user interface 600.

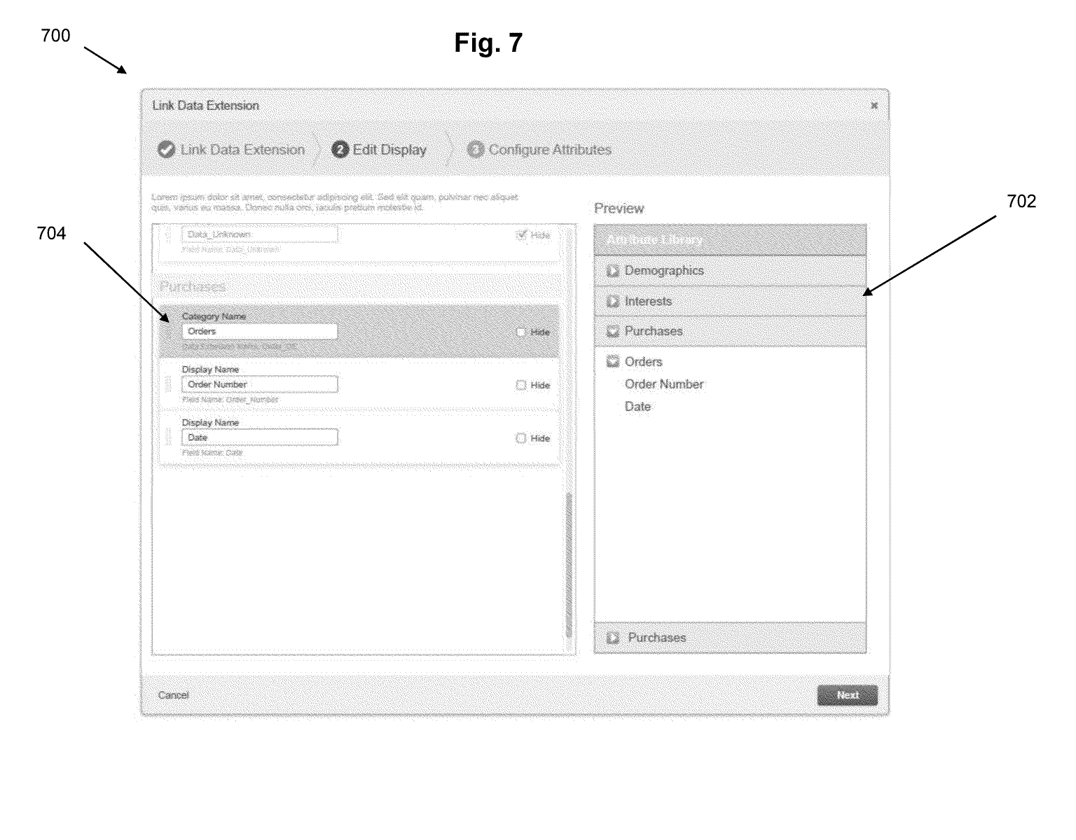

Referring now to FIG. 7, it is shown a graphical user interface of a link data extension 700 in an audience builder system according to at least one embodiment of the present disclosure. As shown in FIG. 7, the link data extension 700 includes a set of selectable attributes 704 and a preview of the selectable attributes 702. In at least one embodiment of the present disclosure, the link data extension 700 allows a user to select a list of attributes stored within a database to use when building a Boolean expression in a graphical user interface as shown in FIG. 1. In at least one embodiment of the present disclosure, the list of attributes 704 populates from a database in the audience builder system which includes attributes and audience demographic information for each audience member. In at least one embodiment of the present disclosure, a user may hide or show each attribute to use in the graphical user interface to create a Boolean expression. In at least one embodiment of the present disclosure, the preview 702 shows the user a point-in-time representation of what attributes would be available in the attribute library in the event that the user chooses to create a Boolean expression with the chosen attributes.

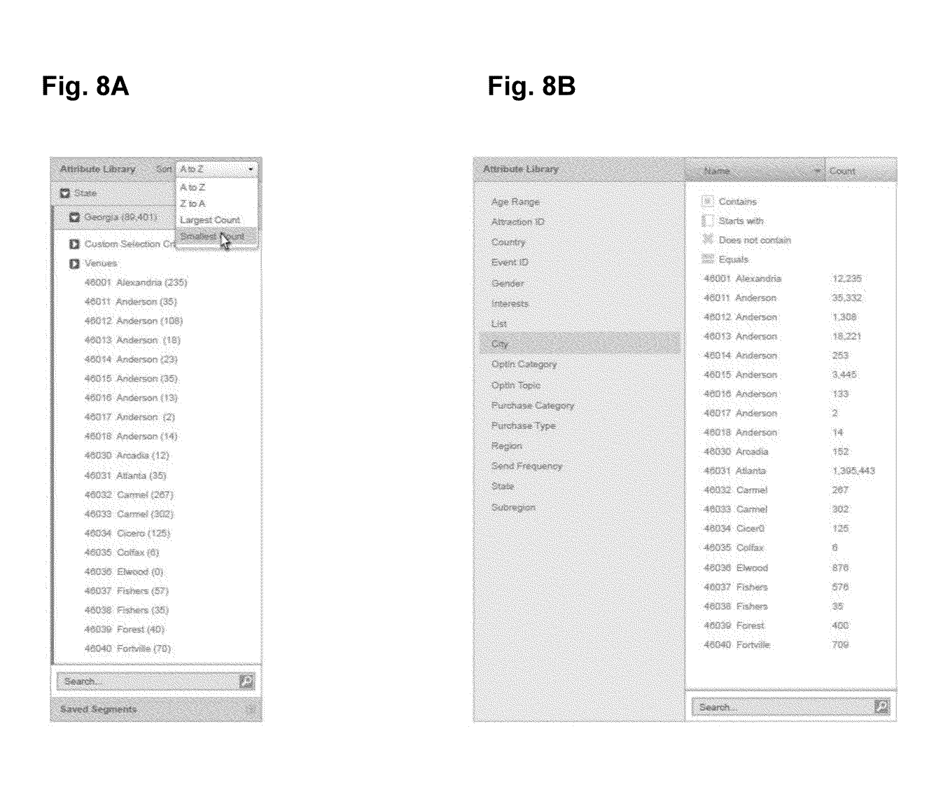

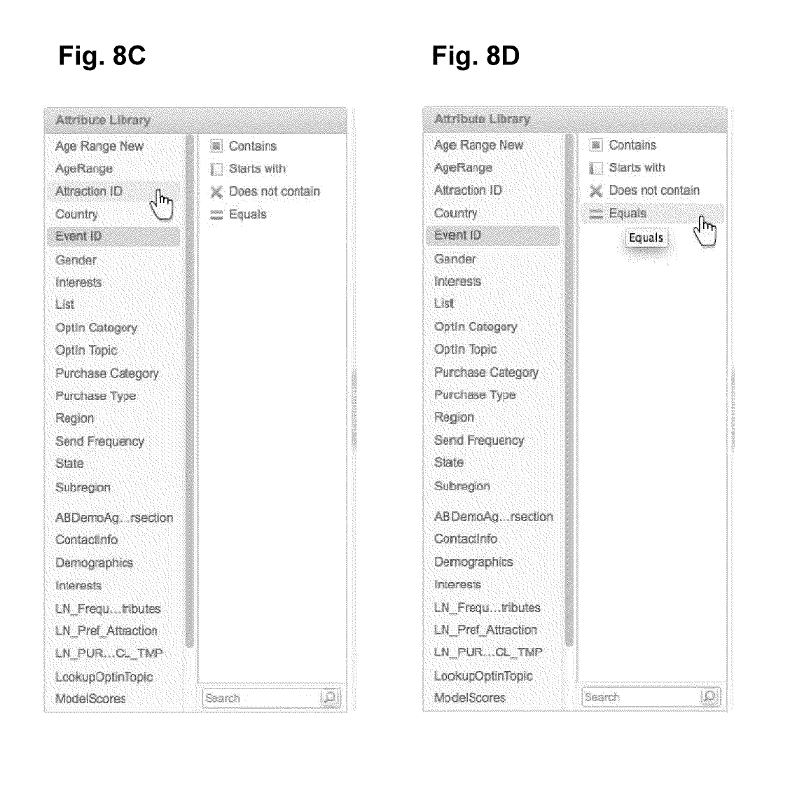

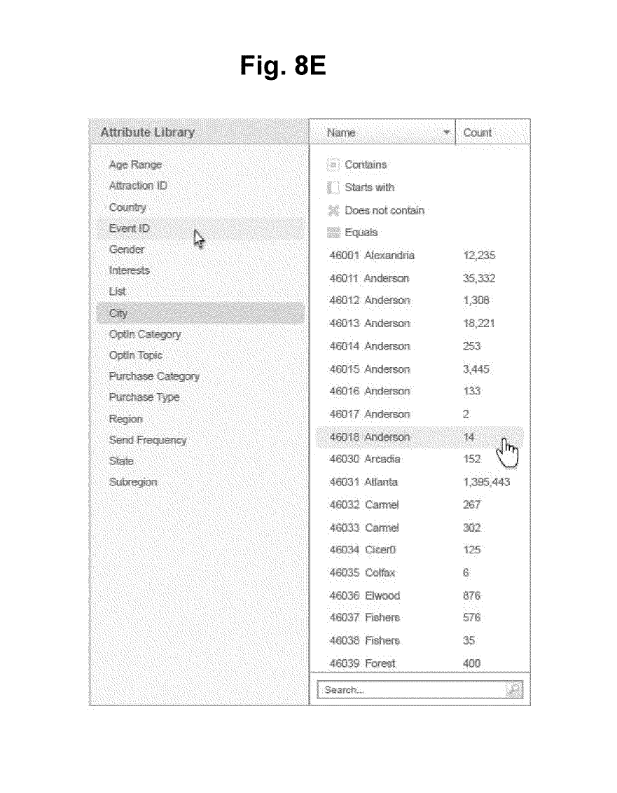

In at least one embodiment of the present disclosure, a user may sort attribute values within an attribute library based on information stored in a database associated with such attributes. It should be appreciated that the ability for the user to sort the attribute values allows the user to more quickly define a create a Boolean expression based on the attributes to obtain the desired target audience. Referring now to FIG. 8A, it is shown a graphical user interface allowing a user to sort the selected attribute values within an attribute library. In at least one embodiment of the present disclosure, the user may sort the attribute values based on information associated with each attribute value. As shown, for example, in FIG. 8A, each attribute value in the attribute library may be sorted alphabetically or by the number of audience members within a database corresponding to each attribute value.

In at least one embodiment of the present disclosure, information corresponding to each attribute in the attribute library is shown in the graphical user interface to aid the user in creating a Boolean expression that will generate the desired target audience. For example, as shown in FIG. 8A, each attribute value is associated with an attribute value identifier and a count corresponding to the number of entries each attribute value has in the corresponding database. In this example, the user may select attributes to view corresponding attribute values and other information. Additionally, the user may search for attribute values, attributes, and other information available to the user. For example, as shown, the attribute value Alexandria corresponding to the attribute “Venues” is associated with an attribute value id of “46001” and is in the database 235 times. In another example, the attribute value “Fortville” corresponding to the attribute “Venues” is associated with an attribute value id of “46040” and is in the database 70 times. It should be appreciated that this information presented to the user enables the user to identify attribute values that are relevant to the user's desired target audience and more quickly and efficiently created a Boolean expression to obtain the desired target audience in the audience builder system. In another example, as shown in FIG. 8B, the user may select attributes within an attribute library to see the corresponding attribute values and other information. In this example, the user may perform search operations on attribute values to identify attribute values that may be of interest. In another example, as shown in FIGS. 8C, 8D and 8E, the user may select attributes individually and perform search operations to find relevant attribute values. It should be appreciated that it is within the scope of this disclosure to present attributes and attribute values in various embodiments in order to allow the user to efficiently and quickly identify attribute values that are of interest to the user to obtain the desired target audience.

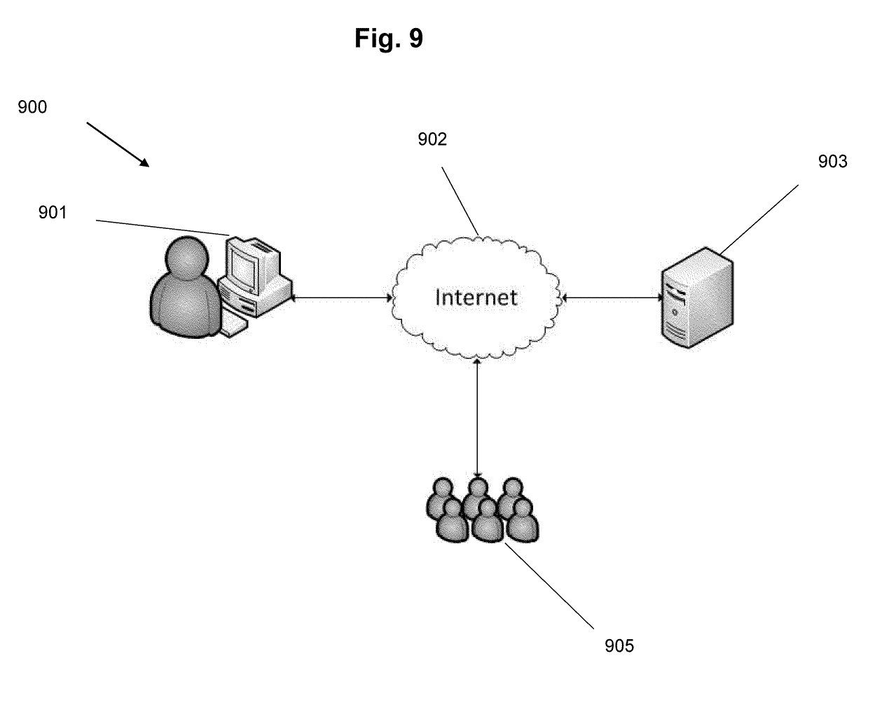

Referring now to FIG. 9, it is shown an audience builder system according to at least one embodiment of the present disclosure. In at least one embodiment of the present disclosure, the audience builder system 900 includes a user 901, a network 902, a server 903, and an audience 905. In such an embodiment, the network 902 may be any computer network, such as, for example, the Internet, Local Area Network, Wide Area Network, or otherwise. In at least one embodiment of the present disclosure, the network 902 connects the user 901 to the server 903 and the audience 905. Nevertheless, it should be appreciated that it is within the scope of the present disclosure that the audience 905 may be disjoint from the network 902.

In at least one embodiment of the present disclosure, the audience builder system 900 includes a server 903. In at least one embodiment of the present disclosure, the server 903 provides a graphical user interface to the audience builder system 900 to the user 901. In such an embodiment, the graphical user interface provided by the server 903 is linked to a back-end database to store user input, created Boolean expressions, defined audiences, and other information generated by the audience builder system 900.

In at least one embodiment of the present disclosure, the server 903 includes a database storing information about audience members. In such an embodiment, the information stored by the database may include, but is not limited to, demographic information, campaign data, identifying information, indices, and other information. In such an embodiment, the information stored in the database is associated with various attributes that are selectable by the user 901 when building an audience with the audience builder system 900.

In at least one embodiment of the present disclosure, the audience builder system 900 generates a target audience based on input from the user device 901 to the graphical user interface provided by the server 903 and the information pulled from its database. In such an embodiment, the target audience is associated with one or more audience members 905. In such an embodiment, the user 901 may create and execute a marketing campaign towards the target audience to send materials to one or more of the audience members 905.

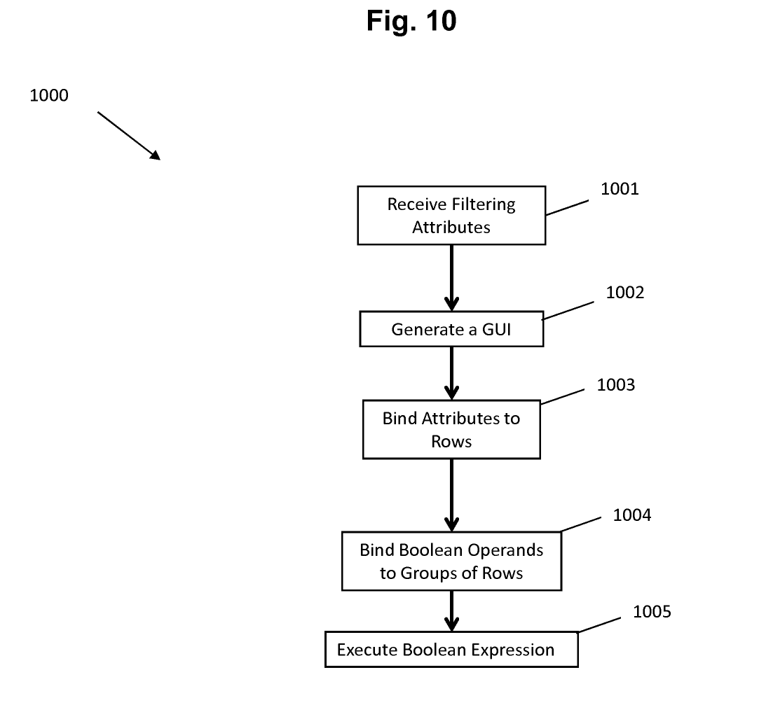

Referring now to FIG. 10, it is shown a method 1000 for generating a graphical user interface to build an audience. As shown in FIG. 10, the method 1000 includes receiving filtering attributes in step 1001, generating a graphical user interface in step 1002, binding attributes to rows in step 10003, binding Boolean operands to groups of rows in step 1004, and executing the resulting Boolean expression in step 1005.

In at least one embodiment of the present disclosure, the method 100 includes receiving filtering attributes in step 1001. In such an embodiment, as discussed previously, the filtering attributes may be stored as attributes in a database to be populated within an attribute library. In at least one embodiment of the present disclosure, the filtering attributes include identifying categories of information known about subscribers within a database of subscribers, such as, for example, city, sex, purchase history, engagement information, opt-in status, and other information. In at least one embodiment of the present disclosure, filtering attributes may be data extension identifiers or other database identifiers which reference sets of aggregated information about a consumer and/or derived information about a consumer. It should be appreciated that the filtering attributes may reside in a single database or multiple databases and the step 1001 of receiving filtering attributes may include receiving filtering attributes from multiple sources.

In at least one embodiment of the present disclosure, the method 1000 includes generating a graphical user interface in step 1002. In such an embodiment, the graphical user interface generated in step 1002 may include an attribute library, filtering pane, and other components shown in FIGS. 1-8E. In at least one embodiment of the present disclosure, generating a graphical user interface in step 1002 includes rendering a graphical user interface in a web browser and/or transmitting a graphical user interface for rendering within a web browser.

In at least one embodiment of the present disclosure, the method 1000 includes binding filtering attributes to rows in step 1003. As discussed previously, the graphical user interface enables a user to select attributes from the attribute library for binding to one or more rows within the filtering pane. In at least one embodiment of the present disclosure, binding attributes to rows in step 1003 enables an enterprise user to interact with the graphical user interface to select attributes and allocate such attributes to one or more rows within the graphical user interface.

In at least one embodiment of the present disclosure, binding attributes to rows in step 1003 includes setting a value and/or range for the attributes bound to each row. For example, an enterprise user binding the age attribute to a row may select an age range between 14-18 years old. In another example, as shown in FIG. 1, binding the Age Range attribute to three rows may enable an end user to select the Age Ranges with ranges of 19-24, 25-34, and 65 and older. In another example, as shown in FIG. 1, an enterprise user may bind a derived attribute to a row, like Customer Tier is of the value High-Value. In this example, the Customer Tier attribute is a derived attribute based upon information stored about the consumer within one or more databases.

In at least one embodiment of the present disclosure, the method 1000 includes binding Boolean operands to groups of rows in step 1004. In such an embodiment, multiple rows may be grouped together using Boolean operands such that the attributes and values are processed in accordance with the grouped Boolean operands.

In at least one embodiment of the present disclosure, the resulting Boolean expression is executed by a server to generate an audience in step 1005. In such an embodiment, the execution of steps 1001 through 1004 creates a Boolean expression that may be used to filter a set of subscribers to a subset of such subscribers to use as a target audience in a marketing campaign.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for generating a graphical user interface to build an audience, the method comprising:
receiving a plurality of filtering attributes from a database, the filtering attributes representing characteristics associated with a plurality of recipients;
generating a graphical user interface comprising a plurality of lines and at least one Boolean operand;
inserting at least one attribute and at least one range to each line of the plurality of lines;
grouping at least two lines of the plurality of lines with the at least one Boolean operand to generate a Boolean expression, the Boolean expression based at least in part on the at least one attribute and the at least one range of the at least two lines of the plurality of lines; and
selecting a subset of recipients from the plurality of recipients by evaluating the characteristics in the database against the Boolean expression.

2. The method of claim 1, further comprising generating a mailing list including each recipient of the subset of recipients.

3. The method of claim 2, further comprising sending a communication to each recipient of the subset of recipients.

4. The method of claim 1, wherein the graphical user interface comprises a second Boolean operand.

5. The method of claim 4, further comprising grouping a plurality of the grouped lines with the second Boolean operand to generate the Boolean expression.

6. The method of claim 1, wherein the graphical user interface is configured to enable a user to drag and drop the plurality of filtering attributes onto the plurality of lines.

7. The method of claim 1, wherein the graphical user interface is configured to enable a user to drag and drop each of the plurality of lines to a new position within the plurality of lines.

8. The method of claim 1, wherein the graphical user interface is configured to enable a user to select at least three of the plurality of lines in the grouping step.

9. The method of claim 1, wherein the at least one range is a pre-defined attribute type.

10. The method of claim 1, wherein the plurality of filtering attributes is received from a plurality of databases.

11. The method of claim 1, wherein the graphical user interface is configured to enable a user to build a visual representation of a Boolean expression by dragging and dropping any of the plurality of lines, the at least one Boolean operand, and the plurality of filtering attributes.

12. The method of claim 1, wherein the characteristics are demographics.

13. A system for generating a graphical user interface to build an audience, the system comprising:
a database, the database configured to store a plurality of filtering attributes, a plurality of recipients, and at least one characteristic associated with each recipient of the plurality of recipients;
a server, the server electronically coupled to the database and configured to pull the plurality of filtering attributes, the plurality of recipients, and the at least one characteristic from the database;
wherein the server is further configured to generate a graphical user interface comprising a plurality of lines and a Boolean operand, the graphical user interface configured to enable a user to associate the plurality of filtering attributes with the plurality of lines and group at least two of the plurality of lines with a Boolean operand to generate a Boolean expression.

14. The system of claim 13, wherein the at least one characteristic is a demographic information.

15. The system of claim 13, wherein the at least one characteristic is a purchase history.

16. The system of claim 13, wherein the server is further configured to generate a mailing list from the plurality of recipients by executing the Boolean expression.

17. The system of claim 13, wherein the graphical user interface is further configured to enable a user to drag and drop each of the plurality of lines, the Boolean operand, and the filtering attributes.

18. A computerized method to build an audience, the method comprising:
receiving a set of attributes through a graphical user interface from a user over a network, the graphical user interface being configured to enable a user to build a Boolean expression associated with the set of attributes;
receiving a Boolean expression associated with the set of attributes through the graphical user interface; and
identifying a subset of recipients from a plurality of recipients by evaluating the Boolean expression against characteristics associated with the plurality of recipients.

19. The method of claim 18, wherein the graphical user interface is presented to the user through a web service.

20. The method of claim 18, wherein the characteristics includes at least one of demographic information, purchase history, and expected engagement.
